(19) United States
(12) Patent Application Publication
(10) Pub. No.: US 2018/0173728 A1
(43) Pub. Date: Jun. 21, 2018

(54) INFORMATION PROCESSING APPARATUS AND METHOD

(71) Applicant: FUJITSU LIMITED, Kawasaki-shi (JP)

(72) Inventor: Satoshi Munakata, Kawasaki (JP)

(73) Assignee: FUJITSU LIMITED, Kawasaki-shi (JP)

(21) Appl. No.: 15/814,722

(22) Filed: Nov. 16, 2017

(30) Foreign Application Priority Data
Dec. 16, 2016 (JP) 2016-244816

(51) Int. Cl. G06F 17/30

(52) U.S. Cl. CPC G06F 17/30289; G06N 7/005

(57) ABSTRACT

An information processing apparatus includes a memory; and a processor coupled to the memory, and the processor configured to: predict whether a lifetime of an object, the object being generated at time of execution, is longer than a given threshold value, and process a first processing for storing an address of the object when the lifetime of the object is longer than the given threshold value and a second processing for converting the address of the object into an integer value to store the integer value when the lifetime of the object is not longer than the given threshold value.

### CROSS-REFERENCE TO RELATED APPLICATION

This application is based upon and claims the benefit of priority of the prior Japanese Patent Application No. 2016-244816, filed on Dec. 16, 2016, the entire contents of which are incorporated herein by reference.

### FIELD

The embodiments discussed herein are related to an information processing apparatus and an information processing method.

### BACKGROUND

In order to investigate a cause of an error which has occurred during an execution of a program, an execution history of the program is collected. A developer of the program analyzes a source code based on the execution history so as to identify a defective part of the program.

There is a technique in which an object is created in a first memory region or a second memory region, in which at least a part of the object may be efficiently written, in accordance with a confirmation result of whether or not a permanent reference is generated with respect to a newly created object, in compilation. According to this technique, it is possible to efficiently utilize the second memory which enables efficient writing.

Further, there is a technique in which when a lifetime of an object to be generated is not included in a lifetime of an object about a root class and an average value of lifetimes corresponding to a set of objects to which the object to be generated belongs is equal to or larger than a threshold value, the object is arranged in an external heap as a long-lived object. According to this technique, it is possible to speed up a program utilizing an object, by excluding long-lived objects from objects of garbage collection.

Japanese National Publication of International Patent Application No. 2006-525568 and Japanese Laid-open Patent Publication No. 2010-044532 are examples of related art.

Collection of an execution history of a program has a problem in which a load on the program is increased because the collection is executed by inserting a collection code into the program.

Accordingly, in the case where an execution history of a program is collected, a load on the program is requested to be suppressed as much as possible.

### SUMMARY

According to an aspect of the embodiments, an information processing apparatus includes a memory; and a processor coupled to the memory, and the processor configured to: predict whether a lifetime of an object, the object being generated at time of execution, is longer than a given threshold value, and process a first processing for storing an address of the object when the lifetime of the object is longer than the given threshold value and a second processing for converting the address of the object into an integer value to store the integer value when the lifetime of the object is not longer than the given threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a first diagram for illustrating collection of an execution history;

FIG. 1B is a second diagram for illustrating collection of an execution history;

FIG. 1C is a third diagram for illustrating collection of an execution history;

FIG. 1D is a fourth diagram for illustrating collection of an execution history;

FIG. 1E is a fifth diagram for illustrating collection of an execution history;

FIG. 1F is a sixth diagram for illustrating collection of an execution history;

FIG. 1G is a seventh diagram for illustrating collection of an execution history;

FIG. 2 is a diagram for illustrating a lifetime of an object;

FIG. 3 is a flowchart illustrating a flow of an outline of processing performed by an information processing apparatus according to a first embodiment;

FIG. 4 is a diagram for illustrating an example of processing performed by the information processing apparatus according to the first embodiment;

FIG. 5 is a diagram for illustrating the configuration of the information processing apparatus according to the first embodiment;

FIG. 6 is a diagram for illustrating the functional configuration of a system program;

FIG. 7 is a diagram for illustrating an example of processing for recording use time and collection time of an object;

FIG. 8 is a diagram for illustrating an example of a prediction result storage section;

FIG. 9 is a diagram for illustrating an example of an execution history storage section;

FIG. 10 is a diagram for illustrating an example of a bytecode storage section;

FIG. 11 is a flowchart illustrating a flow of processing performed by the information processing apparatus;

FIG. 12 is a flowchart illustrating a flow of processing of step S11;

FIG. 13 is a flowchart illustrating a flow of processing of step S12;

FIG. 14 is a flowchart illustrating a flow of processing of step S13;

FIG. 15 is a flowchart illustrating a flow of processing of step S14;

FIGS. 16A and 16B are diagrams for illustrating a string representation of an execution state;

FIG. 17 is a diagram for illustrating a bytecode before conversion;

FIG. 18 is a diagram for illustrating a prediction bytecode;

FIG. 19 is a diagram for illustrating a collection bytecode;

FIG. 20 is a diagram for illustrating a collected execution history;

FIG. 21 is a flowchart illustrating a flow of processing performed by an information processing apparatus according to a second embodiment;

FIG. 22 is a diagram for illustrating a collection bytecode into which an execution history collection code is inserted assuming that prediction results of a lifetime of an object are all long-lived;

FIG. 23 is a diagram for illustrating a collection bytecode into which an execution history collection code is reinserted based on a prediction result of an object lifetime;

FIG. 24 is a diagram for illustrating a method for referring to a prediction result at the time of execution history collection;

FIG. 25 is a flowchart illustrating a flow of processing performed by an information processing apparatus according to a third embodiment; and

FIG. 26 is a flowchart illustrating a flow of processing performed by an information processing apparatus according to a fourth embodiment.

### DESCRIPTION OF EMBODIMENTS

Hereinafter, an information processing apparatus, an information processing method, and a program according to embodiments of the present disclosure will be detailed with reference to the accompanying drawings. Here, the embodiments do not limit the disclosed technique.

### First Embodiment

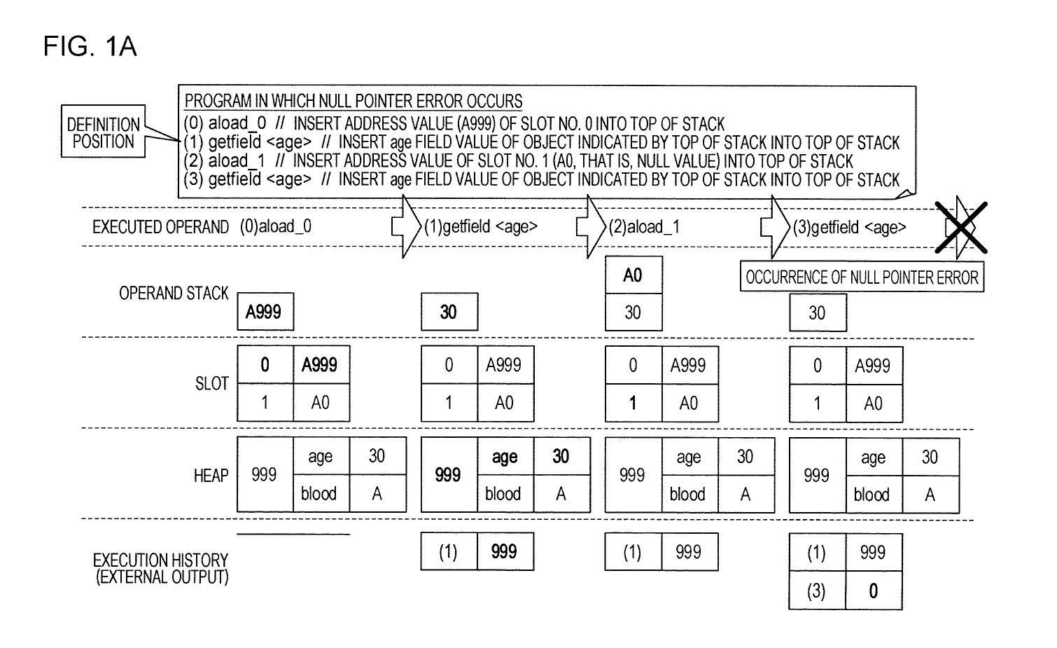

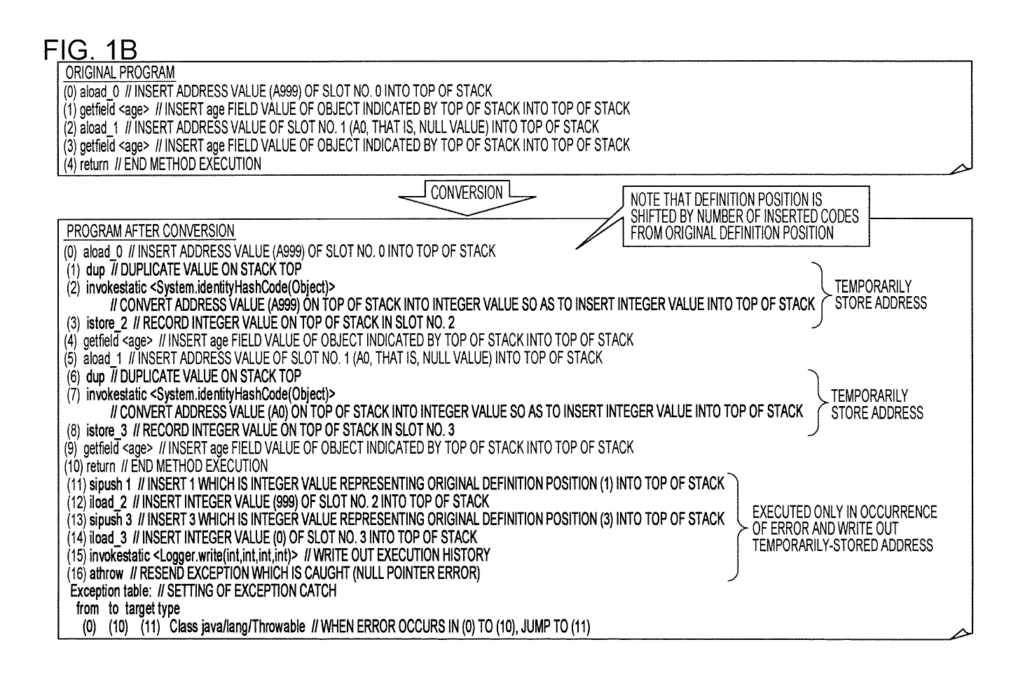

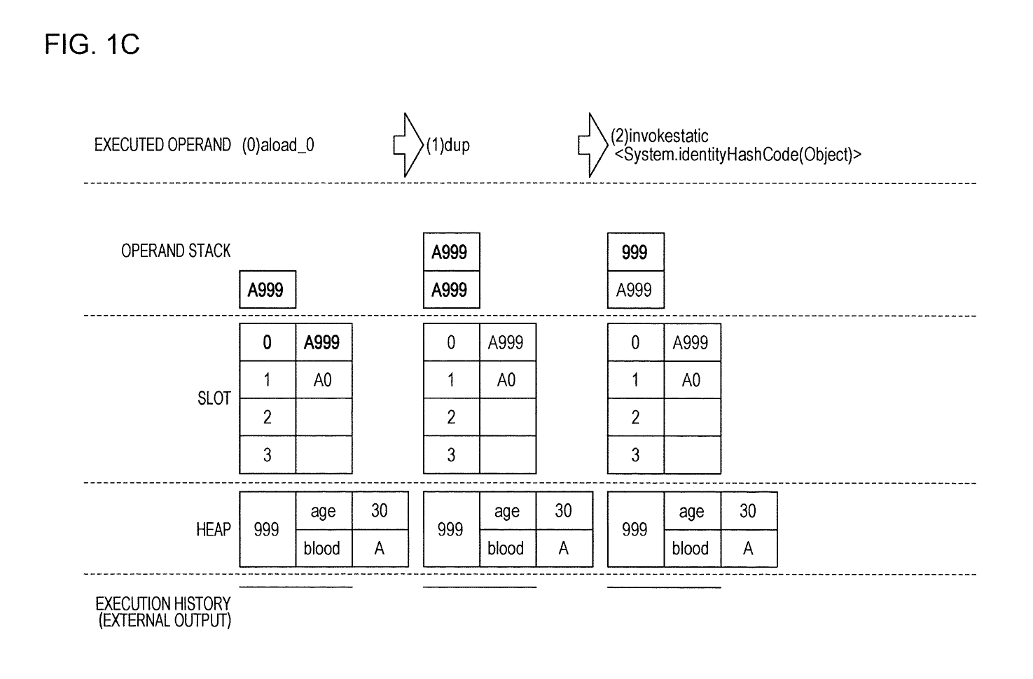

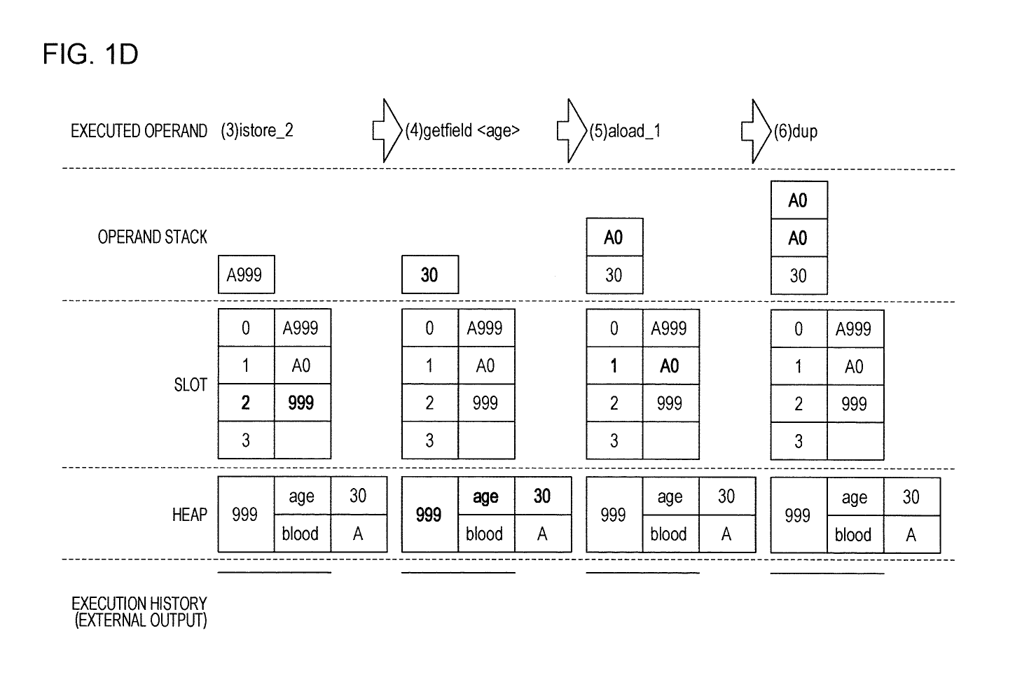

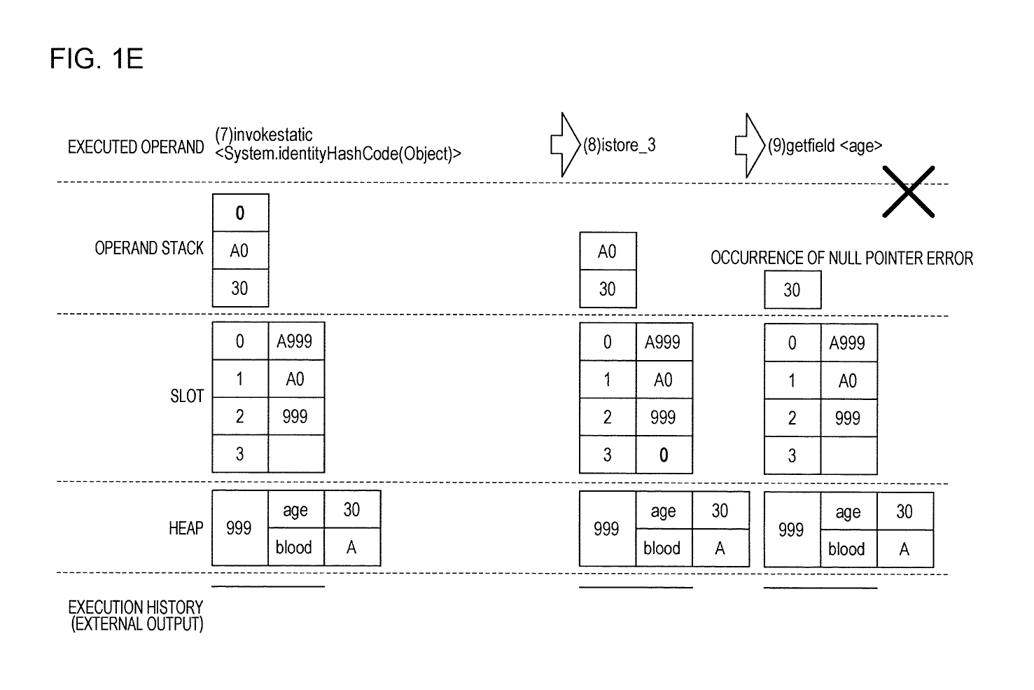

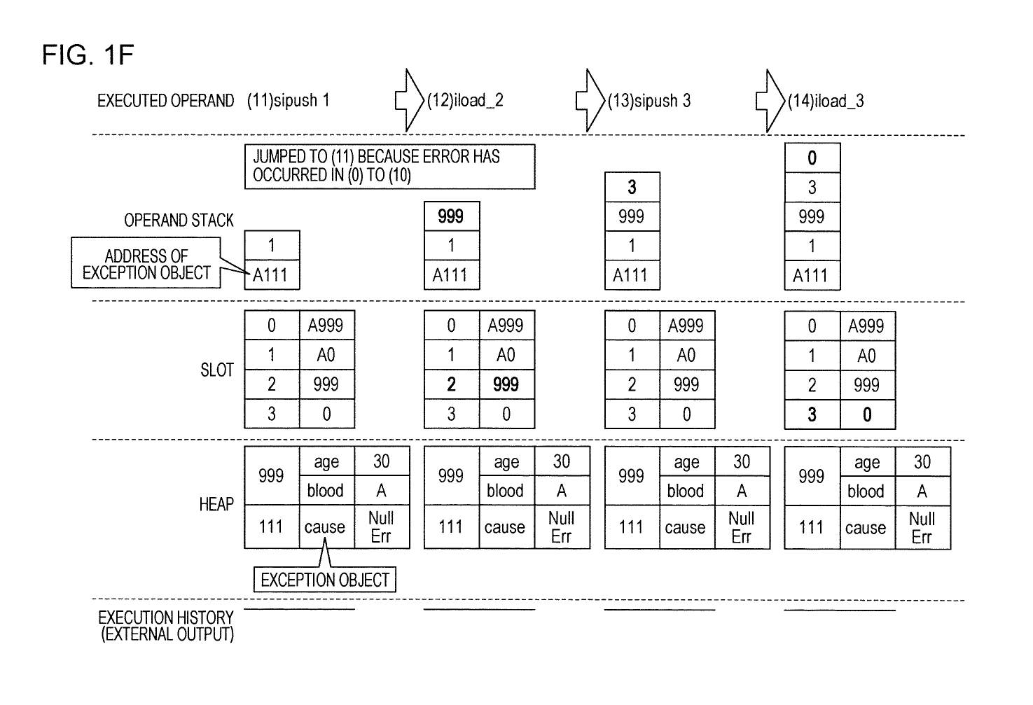

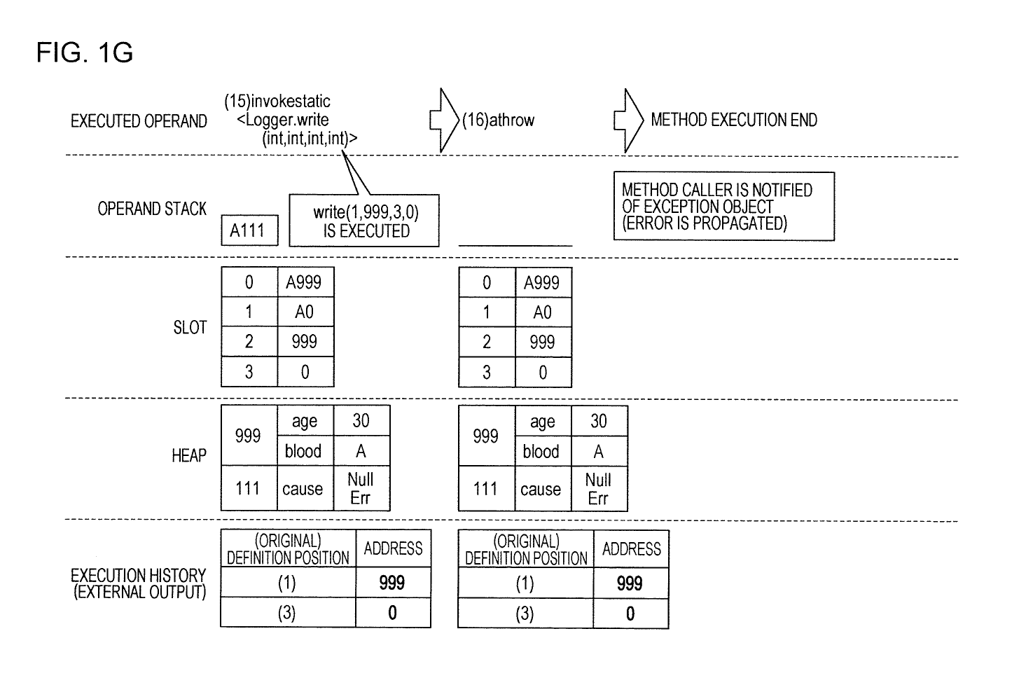

Collection of an execution history will be first described. FIGS. 1A to 1G are diagrams for illustrating collection of an execution history. In FIG. 1A, a program in which a null pointer error occurs is a bytecode of Java (trademark; the same shall apply hereinafter) and a character string following “//” is a comment. The program is a list composed of a plurality of operands (instructions) for operating a stack. Here, “A999”, “A111”, “A0”, “A777”, “A222”, “A555”, and the like described below are name tags corresponding to addresses. Examples of an operand include a read instruction for inserting data into the top of a stack and an operation instruction for processing data on the top of a stack.

An operand stack is a stack operated by operands. A slot is a temporary storage region for data. A slot may be realized by a register, for example. A heap may be a dynamically securable memory region. An object is recorded in the heap and an address of an object is handled in the operand stack and the slot. Here, “an address of an object” is an identifier by which the object is uniquely identified at a point in program execution.

An execution history is information to be collected. An address of an object used in operand execution and a definition position of the operand are collected as data of an execution history. A definition position of an operand is represented by a number in a parenthesis provided on the left of each operand. Further, parts indicated in boldface in FIG. 1A and other diagrams are data, addresses, field names, and the like which are referred to and operated by corresponding operands.

As illustrated in FIG. 1A, (0) aload_0 is executed and the address value (A999) of slot no. 0 is inserted into the top of the operand stack. Here, “A999” represents an address value which is converted into an integer value “999”. Here, in comments in FIG. 1A and other diagrams, an “operand stack” is simply described as a “stack”.

Then, (1) getfield <age> is executed and an age field value of an object indicated by the top of the operand stack is inserted into the top of the operand stack. In FIG. 1A, “30” is inserted into the top of the operand stack. Further, since the object is used, the definition position (1) of the operand and the value “999”, which is obtained by converting the address “A999” of the object into an integer value, are collected.

Subsequently, (2) aload_1 is executed and the address value of slot no. 1 (A0, that is, a null value) is inserted into the top of the operand stack. Then, (3) getfield <age> is executed, and the address of the object indicated by the top of the operand stack is “A0”, so that a null pointer error occurs. In addition, since the object is used, the definition position (3) of the operand and the value “0”, which is obtained by converting the address “A0” of the object into an integer value, are collected.

In order to collect the execution history illustrated in FIG. 1A, an execution history collection code has to be inserted into an original program. FIG. 1B illustrates a program after conversion which is converted from an original program through insertion of an execution history collection code. In FIG. 1B, codes of the definition positions (1) to (3), codes of the definition positions (6) to (8), and codes of the definition positions (11) to (16) are codes inserted into the original program. Here, the definition position is shifted by the number of the inserted codes. The codes of the definition positions (1) to (3) and the codes of the definition positions (6) to (8) are codes for converting an address of an object into an integer and temporarily storing the integer in the slot. The codes of the definition positions (11) to (16) are codes for writing out temporarily-stored addresses and are executed only when an error occurs.

The program after conversion illustrated in FIG. 1B is executed as illustrated in FIGS. 1C to 1G. First, as illustrated in FIG. 1C, (0) aload_0 is executed and the address value (A999) of slot no. 0 is inserted into the top of the operand stack. Then, (1) dup is executed and the value on the top of the operand stack is duplicated. In FIG. 1C, “A999” is duplicated. Subsequently, (2) invokestatic <System.identityHashCode(Object)> is executed, and the address value (A999) on the top of the operand stack is converted into the integer value (999) to be inserted into the top of the operand stack.

Then, as illustrated in FIG. 1D, (3) istore_2 is executed and the integer value on the top of the operand stack is recorded in slot no. 2. After that, (4) getfield <age> is executed and an age field value of the object indicated by the top of the operand stack is inserted into the top of the operand stack. In FIG. 1D, “30” is inserted into the top of the operand stack.

Then, (5) aload_1 is executed and the address value (A0) of slot no. 1 is inserted into the top of the operand stack. Subsequently, (6) dup is executed and the value on the top of the operand stack is duplicated. In FIG. 1D, “A0” is duplicated.

After that, as illustrated in FIG. 1E, (7) invokestatic <System.identityHashCode(Object)> is executed and the address value (A0) on the top of the operand stack is converted into the integer value (0) to be inserted into the top of the operand stack. Subsequently, (8) istore_3 is executed and the integer value on the top of the operand stack is recorded in slot no. 3. Then, (9) getfield <age> is executed, and the address of the object indicated by the top of the operand stack is “A0”, so that a null pointer error occurs.

Since the error has occurred, (11) sipush 1 is executed and the integer value “1” representing the original definition position (1) is inserted into the top of the operand stack, as illustrated in FIG. 1F. Then, (12) iload_2 is executed and the integer value (999) of slot no. 2 is inserted into the top of the operand stack. After that, (13) sipush 3 is executed and the integer value “3” representing the original definition position (3) is inserted into the top of the operand stack. Then, (14) iload_3 is executed and the integer value (0) of slot no. 3 is inserted into the top of the operand stack.

Subsequently, as illustrated in FIG. 1G, (15) invokestatic <Logger.write(int,int,int,int)> is executed and the four integers stacked on the operand stack are written out as an execution history. Then, (16) athrow is executed and the null pointer error is resent.

In this way, an execution history is collected by inserting an execution history collection code into an original program. However, the program after conversion illustrated in FIG. 1B has a problem that it takes time to execute the codes (2) and (7) for converting an address of an object into an integer. Since the address value “A999” illustrated in FIGS. 1A to 1G becomes “999” when converted into an integer value, “A999” is used as the address value for convenience of explanation. However, the conversion from the address value “A999” into the integer value “999” takes approximately 100 times as long as the time taken for substitution into a local variable, for example. Also, the execution of the codes (2) and (7) for converting an address of an object into an integer is unwanted when no error occurs.

Therefore, it is conceivable to perform processing for converting an address of an object into an integer after an occurrence of an error. However, there is a possibility that an object is deleted during execution. When an object is deleted, an address of the object also disappears, so that it becomes impossible to convert the address of the object into an integer after an occurrence of an error. Therefore, it is desired to temporarily store an address of an object as a strong reference to avoid deletion of the object.

However, if an address of an object is maintained as a strong reference, garbage collection is not performed even with respect to short-lived objects, taking extra memory usage. Therefore, it is desired to avoid increase of execution time without increasing memory usage.

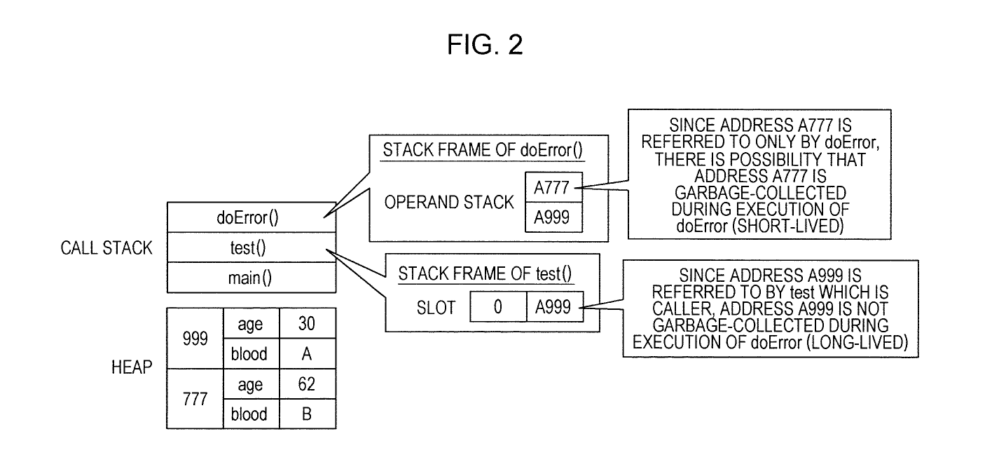

Hence, an information processing apparatus according to the first embodiment determines timing to convert an address of an object into an integer based on a lifetime of the object. FIG. 2 is a diagram for illustrating a lifetime of an object. In FIG. 2, a stack frame is a pair of an operand stack and a slot and manages one execution state of one method. Further, a call stack manages a plurality of stack frames corresponding to execution states of a plurality of methods on one thread. FIG. 2 illustrates the case where a main method calls a test method and the test method calls a doError method and illustrates stack frames corresponding to execution states of the doError method and the test method.

In FIG. 2, since the address “A777” included in the doError( ) operand stack is not included in the test( )operand stack and is referred to only by doError, there is a possibility that the address “A777” is garbage-collected during the execution of doError. That is, an object whose address is “A777” is short-lived. Meanwhile, since the address “A999” included in the doError( ) operand stack is also included in the test( )operand stack and is referred to also by test, the address “A999” is not garbage-collected during the execution of doError. That is, an object whose address is “A999” is long-lived.

Thus, an execution period of a method and a lifetime of an object do not match. In particular, objects referred to by a plurality of threads and a plurality of stack frames are more likely to continue to survive in a heap without being garbage-collected for a longer period of time than lifetimes of many inner stack frames, that is, execution periods of methods.

Thus, since an object having a longer life than an execution period of a method is not to be garbage-collected during an execution of the method, the information processing apparatus according to the first embodiment temporarily stores an address value and converts the address value into an integer value after an occurrence of an error. Meanwhile, since an object whose life is shorter than an execution period of a method is to be garbage-collected during an execution of the method, the information processing apparatus according to the first embodiment converts an address value into an integer value and temporarily stores the integer value.

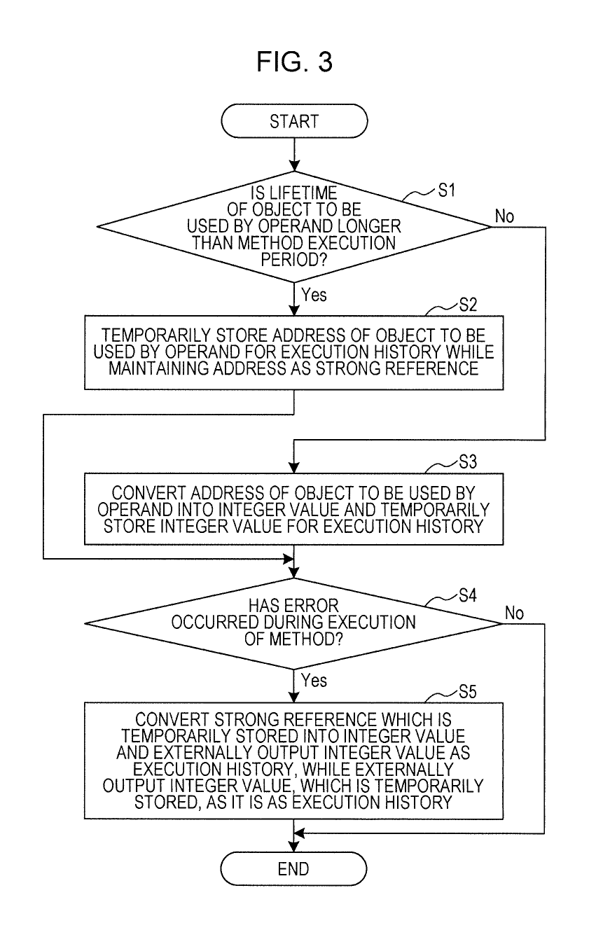

FIG. 3 is a flowchart illustrating a flow of an outline of processing performed by the information processing apparatus according to the first embodiment. As illustrated in FIG. 3, the information processing apparatus according to the first embodiment determines whether or not a lifetime of an object to be used by an operand is longer than a method execution period (step S1). In the case where the lifetime of the object to be used by the operand is longer than the method execution period, the information processing apparatus according to the first embodiment temporarily stores an address of the object to be used by the operand for execution history while maintaining the address as a strong reference (step S2). On the other hand, in the case were the lifetime of the object to be used by the operand is not longer than the method execution period, the information processing apparatus according to the first embodiment converts the address of the object to be used by the operand into an integer value and temporarily stores the integer value for execution history (step S3).

Then, the information processing apparatus according to the first embodiment performs processing based on whether or not an error has occurred during an execution of the method (step S4). That is, in the case where an error has occurred during the execution of the method, the information processing apparatus according to the first embodiment converts the strong reference which is temporarily stored into an integer value and externally outputs the integer value as the execution history, while the information processing apparatus externally outputs the integer value, which is temporarily stored, as it is as the execution history (step S5).

Thus, the information processing apparatus according to the first embodiment changes the timing, at which the information processing apparatus converts an address of an object into an integer value, based on a method execution period and a lifetime of the object, being able to lower a CPU load without increasing the memory usage.

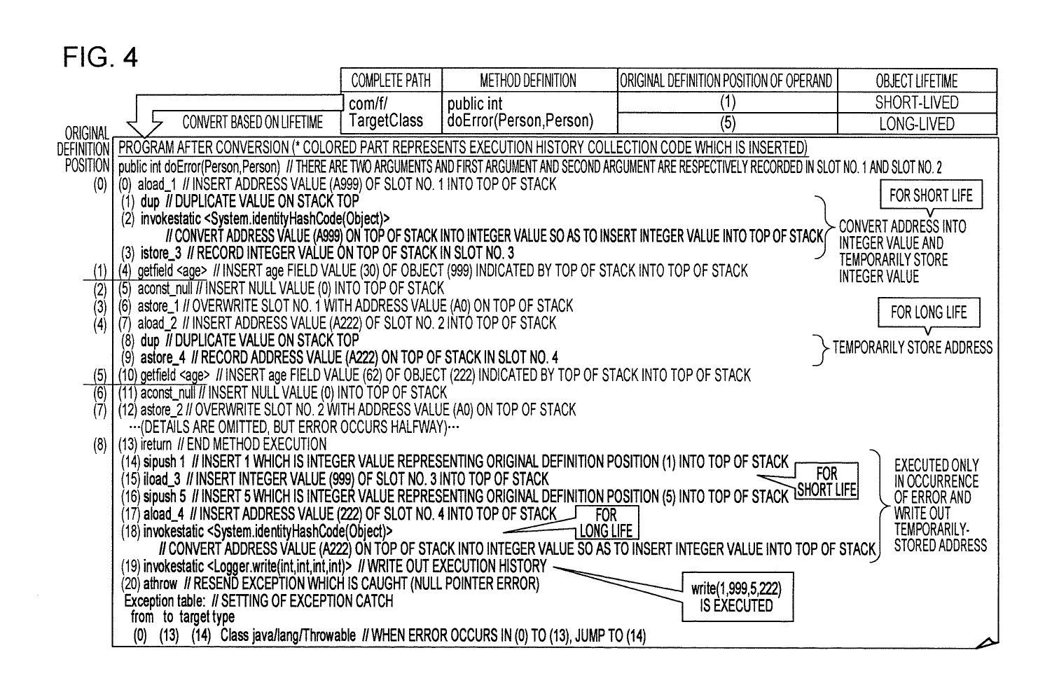

FIG. 4 is a diagram for illustrating an example of processing performed by the information processing apparatus according to the first embodiment. In FIG. 4, it is assumed that the object (A999) corresponding to an operand whose original definition position is (1) is short-lived and the object (A222) corresponding to an operand whose original definition position is (5) is long-lived.

As illustrated as the definition positions (2) and (3) in FIG. 4, since the object (A999) is short-lived, the address value (A999) is converted into an integer value and temporarily stored. On the other hand, as illustrated as the definition position (9), since the object (A222) is long-lived, the address value (A222) is temporarily stored without being converted into an integer value.

Then, when an error occurs, since the integer value is temporarily stored in regard to the object (A999) which is short-lived, the integer value (999) is inserted into the top of the operand stack as illustrated as the definition position (15). On the other hand, since the address value is temporarily stored in regard to the object (A222) which is long-lived, the address value (A222) is converted into the integer value (222) so as to be inserted into the top of the operand stack as illustrated as the definition position (18).

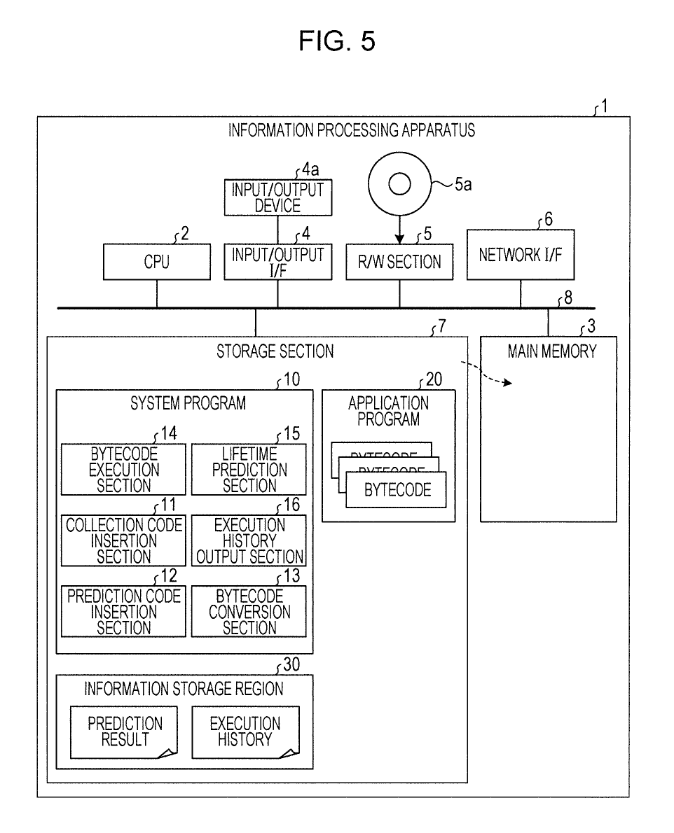

The configuration of the information processing apparatus according to the first embodiment will now be described. FIG. 5 is a diagram for illustrating the configuration of the information processing apparatus according to the first embodiment. As illustrated in FIG. 5, an information processing apparatus 1 according to the first embodiment includes a central processing unit (CPU) 2, a main memory 3, an input/output I/F 4, an input/output device 4a, a R/W section 5, a program storage medium 5a, a network I/F 6, and a storage section 7. The CPU 2, the main memory 3, the input/output I/F 4, the R/W section 5, the network I/F 6, and the storage section 7 are connected to each other via a bus 8.

The CPU 2 is a central processing unit which reads a program from the main memory 3 so as to execute the program. The main memory 3 is a memory which stores a program, an intermediate result of execution of the program, and the like. The input/output I/F 4 is an interface which connects the input/output device 4a and the CPU 2. The input/output device 4a is a device for performing input and output such as a mouse, a keyboard, and a liquid crystal display device. A memory may include the main memory 3, storage section 7.

The R/W section 5 is a device which performs reading from the program storage medium 5a and writing to the program storage medium 5a. The program storage medium 5a is a storage medium such as a DVD, a CD, and a USB memory. The network I/F 6 is an interface for connecting the information processing apparatus 1 to another information processing apparatus and the like via a network.

The storage section 7 is a device which stores programs and data, and is a hard disk drive (HDD), a solid state drive (SSD), or the like. The storage section 7 stores a system program 10 and an application program 20. Further, the storage section 7 includes an information storage region 30 for storing data. A memory coupled to the CPU 2 and may include the main memory 3 and the storage section 7.

A program executed in the information processing apparatus 1 is stored in the program storage medium 5a, read from the program storage medium 5a by the R/W section 5, and installed on the information processing apparatus 1. Alternatively, a program executed in the information processing apparatus 1 is stored in databases or the like of other information processing systems connected via the network I/F 6, read from these databases, installed on the information processing apparatus 1. Then, the program which is installed is stored in the storage section 7, read into the main memory 3, and executed by the CPU 2.

In the information storage region 30, a prediction result of a lifetime of an object and an execution history collected when the program is executed are stored. The execution history includes an address of an object to be used in an operand execution and a definition position of the operand.

The application program 20 includes bytecodes. A bytecode is executed by a bytecode execution section 14.

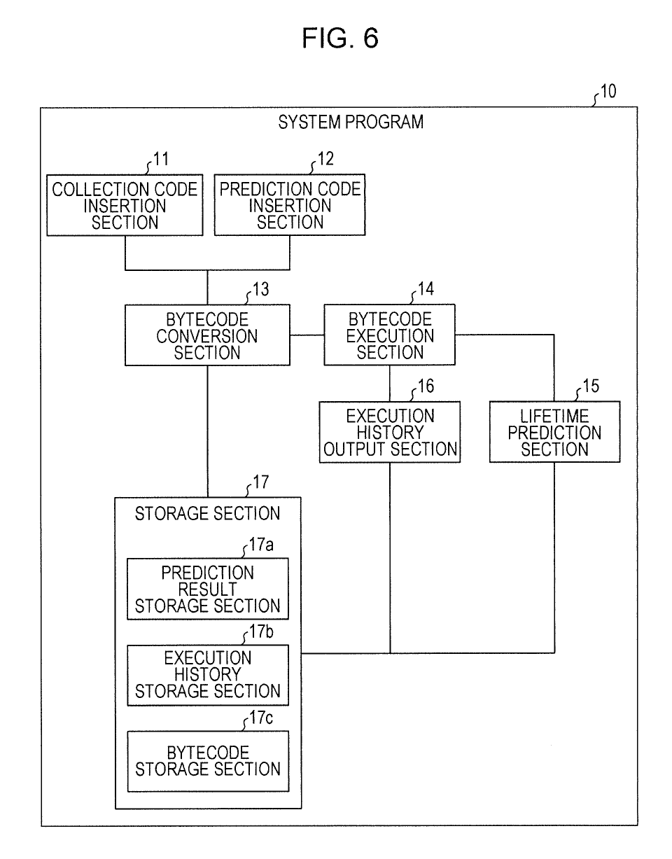

The system program 10 is software used for executing the application program 20. The system program 10 has a function for executing a bytecode and collecting an execution history. FIG. 6 is a diagram for illustrating the functional configuration of the system program 10 regarding the function for executing a bytecode and collecting an execution history.

As illustrated in FIG. 6, the system program 10 includes a collection code insertion section 11, a prediction code insertion section 12, a bytecode conversion section 13, the bytecode execution section 14, a lifetime prediction section 15, an execution history output section 16, and a storage section 17.

The collection code insertion section 11 inserts a code for collecting an execution history into a program from which the execution history is collected. The prediction code insertion section 12 inserts a code for predicting a lifetime of an object into the program from which the execution history is collected.

The collection code insertion section 11 switches a position, into which a code for converting an address of an object into an integer value is inserted, based on a prediction result of a lifetime of an object. That is, the collection code insertion section 11 inserts a code for converting an address of an object into an integer value into processing which is performed at the time of an occurrence of an error in the case where a lifetime of the object is longer than a method execution period. On the other hand, in the case where a lifetime of an object is shorter than a method execution period, the collection code insertion section 11 inserts a code for converting an address of the object into an integer value into a position on which the object has been used.

The bytecode conversion section 13 converts a program into a bytecode. The bytecode execution section 14 executes a bytecode.

The lifetime prediction section 15 executes a code inserted by the prediction code insertion section 12 so as to predict a lifetime of an object and output a prediction result. A tag in which use time and collection time of garbage collection are recorded is added to an object and the lifetime prediction section 15 predicts a lifetime of an object by using the tag. The prediction code insertion section 12 inserts a code for predicting a lifetime of an object and the lifetime prediction section 15 predicts the lifetime of the object based on the code inserted by the prediction code insertion section 12. Then, the collection code insertion section 11 switches and inserts a code for recording an execution history based on the lifetime of the object, and the execution history output section 16 outputs the execution history based on the code inserted by the collection code insertion section 11.

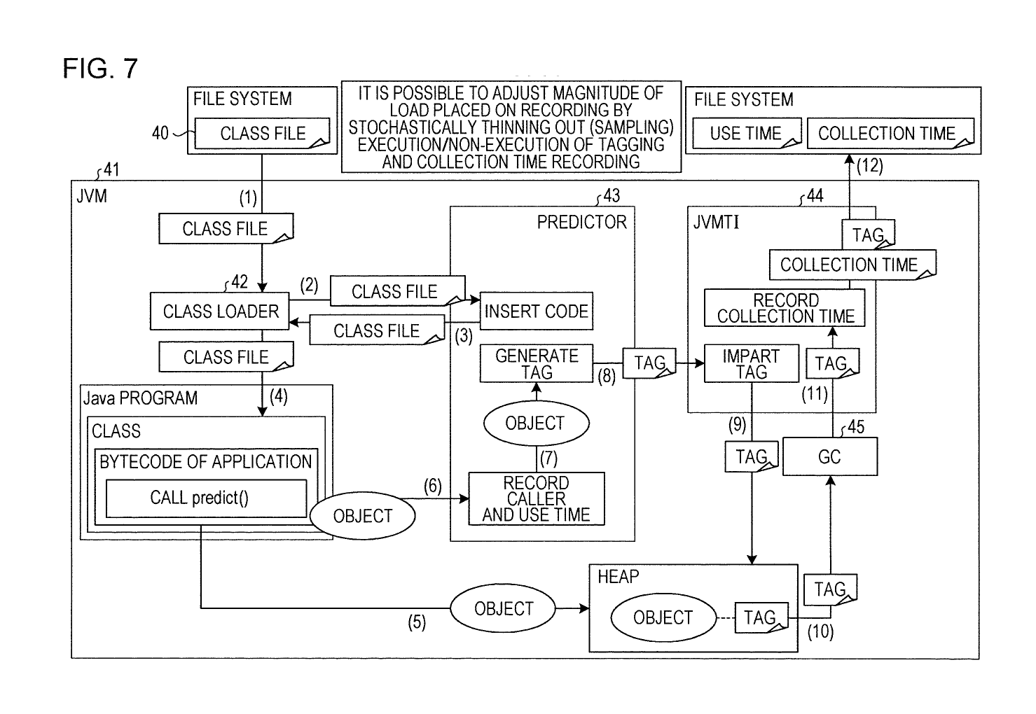

FIG. 7 is a diagram for illustrating an example of processing for recording use time and collection time of an object. As illustrated in FIG. 7, the class loader 42 of the Java virtual machine (JVM) 41 reads a class file 40 (1) and passes the class file 40 to the predictor 43 (2). The predictor 43 inserts a code for calling predict( )into the class file 40 and returns the class file 40 to the class loader 42 (3).

Then, when a class of the class file 40 is executed as a Java program (4) and an object is started to be used (5), predict( )is called (6) and the predictor 43 records a caller and use time (7) and generates a tag in which the caller and the use time are recorded (8).

Subsequently, the JVM tool interface (JVMTI) 44 imparts the tag to the object (9), and when the garbage collector (GC) 45 collects the object, the GC 45 passes the tag to the JVMTI 44 (10 and 11). Then, the JVMTI 44 records collection time in the tag and outputs the use time and the collection time to a file (12). The lifetime of the object is calculated based on the use time and the collection time.

Here, it is possible to adjust the magnitude of a load placed on recording by stochastically thinning out (sampling) execution/non-execution of tagging and collection time recording.

The execution history output section 16 executes a code inserted by the collection code insertion section 11 so as to collect execution history data and output the execution history. The storage section 17 stores information related to a function of executing a bytecode and collecting an execution history. The storage section 17 includes a prediction result storage section 17a, an execution history storage section 17b, and a bytecode storage section 17c.

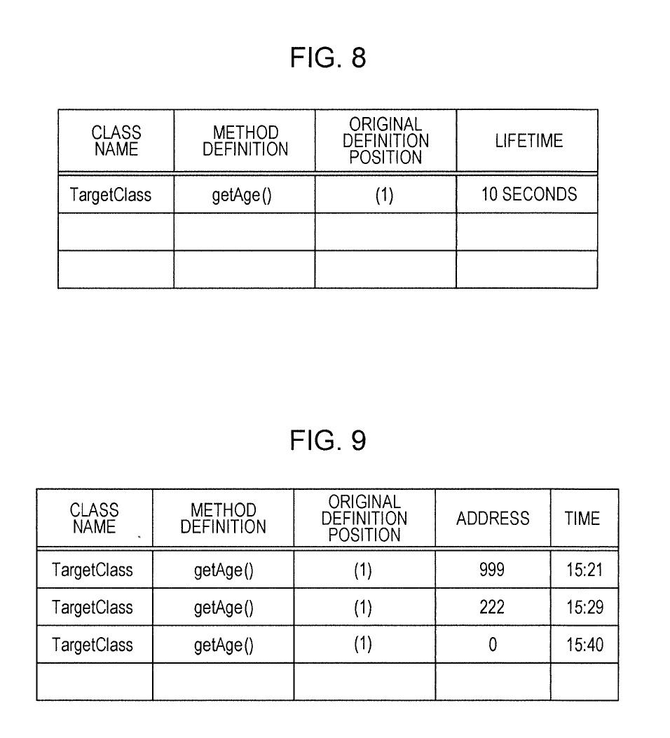

The prediction result storage section 17a stores a prediction result. FIG. 8 is a diagram for illustrating an example of the prediction result storage section 17a. As illustrated in FIG. 8, the prediction result storage section 17a stores a class name, method definition, an original definition position, and a lifetime in association with each object.

Class name represents a name of a class to which an object belongs. Method definition represents a name of a method in which an object is used. Original definition position represents an original definition position of an operand in which an object is used. Lifetime represents a lifetime of an object. For example, a lifetime of an object which belongs to “Target Class”, is used in “getAge”, and corresponds to an operand, whose definition position before insertion of an execution history collection code is (1), is “10 seconds”.

The execution history storage section 17b stores an execution history. FIG. 9 is a diagram for illustrating an example of the execution history storage section 17b. As illustrated in FIG. 9, the execution history storage section 17b stores a class name, method definition, an original definition position, an address, and time for each execution history data.

Class name represents a name of a class to which an object belongs. Method definition represents a name of a method in which an object is used. Original definition position represents an original definition position of an operand in which an object is used. Address represents an integer value converted from an address of an object. Time represents time at which data is collected. For example, an address of an object which belongs to “TargetClass”, is used in “getAge”, and corresponds to an operand, whose definition position before insertion of an execution history collection code is (1), is “999” when converted into an integer value and collection time is “15:21”.

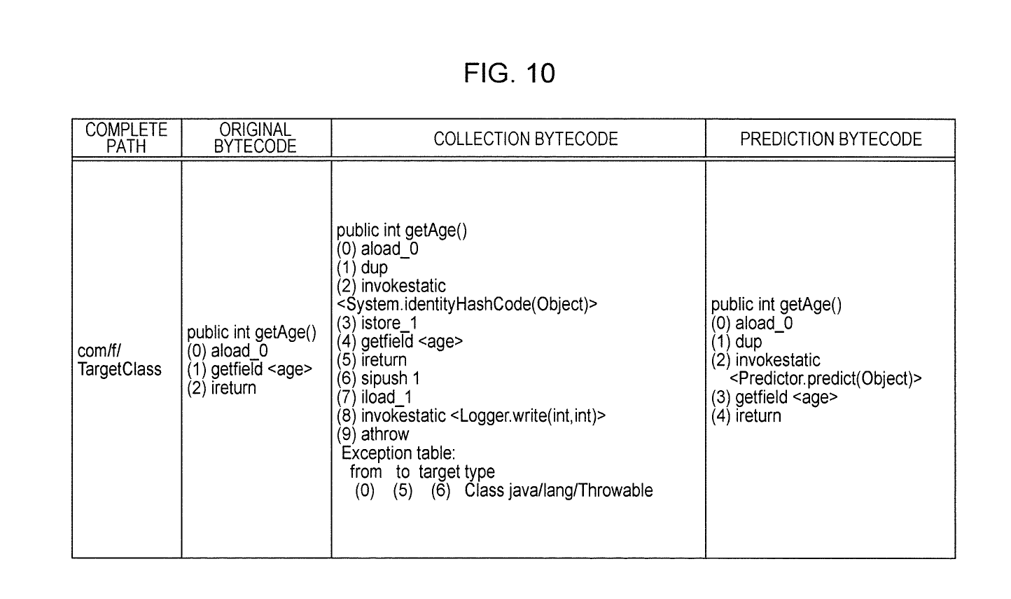

The bytecode storage section 17c stores a bytecode. FIG. 10 is a diagram for illustrating an example of the bytecode storage section 17c. As illustrated in FIG. 10, the bytecode storage section 17c stores a complete path, an original bytecode, a collection bytecode, and a prediction bytecode.

Complete path represents a path to a place in which a bytecode is stored. Original bytecode represents a bytecode with which an original bytecode, that is, an execution history is collected. Collection bytecode represents a bytecode into which a code for collecting an execution history is inserted. Prediction bytecode represents a bytecode into which a code for predicting a lifetime of an object is inserted. A tag in which use time is recorded is generated by (2) invokestatic <Predictor.predict(Object)> in prediction bytecode.

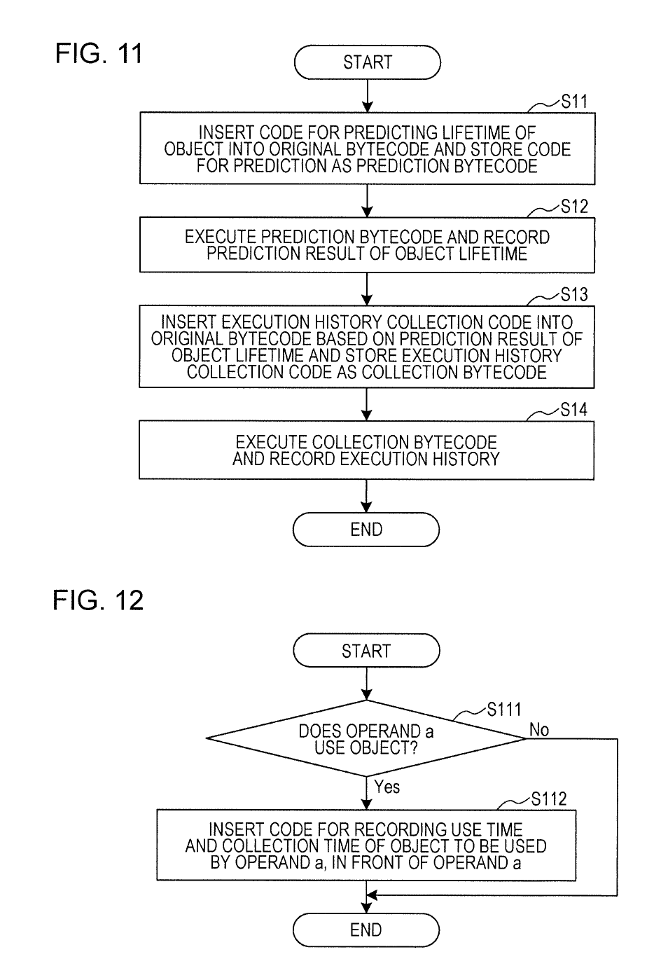

A flow of processing performed by the information processing apparatus 1 will now be described. FIG. 11 is a flowchart illustrating a flow of processing performed by the information processing apparatus 1. As illustrated in FIG. 11, the information processing apparatus 1 inserts a code for predicting a lifetime of an object into an original bytecode and stores the code for prediction as a prediction bytecode (step S11).

Then, the information processing apparatus 1 executes the prediction bytecode and records a prediction result of the object lifetime (step S12). Then, the information processing apparatus 1 inserts an execution history collection code into the original bytecode based on the prediction result of the object lifetime and stores the execution history collection code as a collection bytecode (step S13). Subsequently, the information processing apparatus 1 executes the collection bytecode and records an execution history (step S14).

Thus, the information processing apparatus 1 executes a prediction bytecode to predict an object lifetime, being able to perform insertion of a collection code based on the object lifetime.

FIG. 12 is a flowchart illustrating a flow of processing of step S11. As illustrated in FIG. 12, the prediction code insertion section 12 determines whether or not an operand a uses an object (step S111). In the case where the operand a uses an object, the prediction code insertion section 12 inserts a code for recording use time and collection time of an object to be used by the operand a, in front of the operand a (step S112). Here, the prediction code insertion section 12 performs the processing illustrated in FIG. 12 with respect to each operand of the original bytecode.

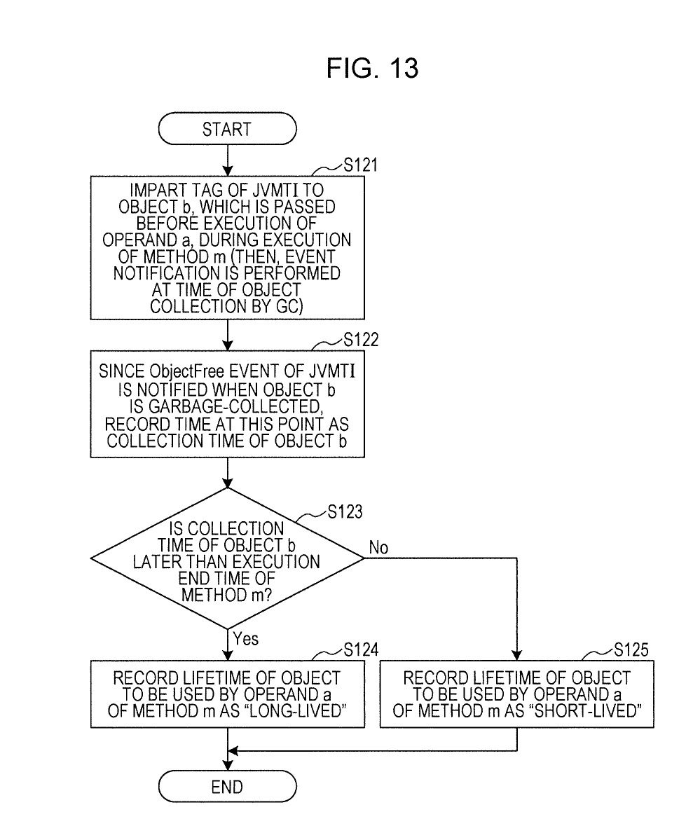

FIG. 13 is a flowchart illustrating a flow of processing of step S12. As illustrated in FIG. 13, the lifetime prediction section 15 imparts a tag of the JVMTI 44 to an object b, which is passed before the execution of the operand a, during an execution of the method m (step S121). Then, event notification is performed at the time of object collection by the GC 45.

Then, since the ObjectFree event of the JVMTI is notified when the object b is garbage-collected, the lifetime prediction section 15 records time at this point as collection time of the object b (step S122). After that, the lifetime prediction section 15 determines whether or not the collection time of the object b is later than execution end time of the method m (step S123).

Then, in the case where the collection time of the object b is later than the execution end time of the method m, the lifetime prediction section 15 records the lifetime of the object to be used by the operand a of the method m as “long-lived” (step S124). On the other hand, in the case where the collection time of the object b is not later than the execution end time of the method m, the lifetime prediction section 15 records the lifetime of the object to be used by the operand a of the method m as “short-lived” (step S125).

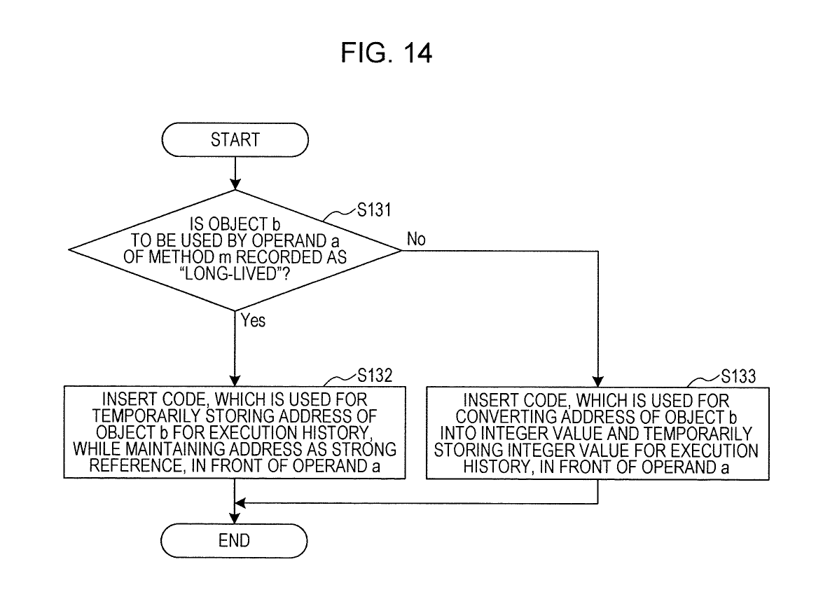

FIG. 14 is a flowchart illustrating a flow of processing of step S13. As illustrated in FIG. 14, the collection code insertion section 11 determines whether or not the object b to be used by the operand a of the method m is recorded as “long-lived” (step S131).

In the case where the object b is recorded as “long-lived”, the collection code insertion section 11 inserts a code, which is used for temporarily storing an address of the object b for an execution history while maintaining the address as a strong reference, in front of the operand a (step S132). On the other hand, in the case where the object b is recorded as “short-lived”, the collection code insertion section 11 inserts a code, which is used for converting the address of the object b into an integer value and temporarily storing the integer value for an execution history, in front of the operand a (step S133). Here, the collection code insertion section 11 performs the processing illustrated in FIG. 14 with respect to each operand of the original bytecode.

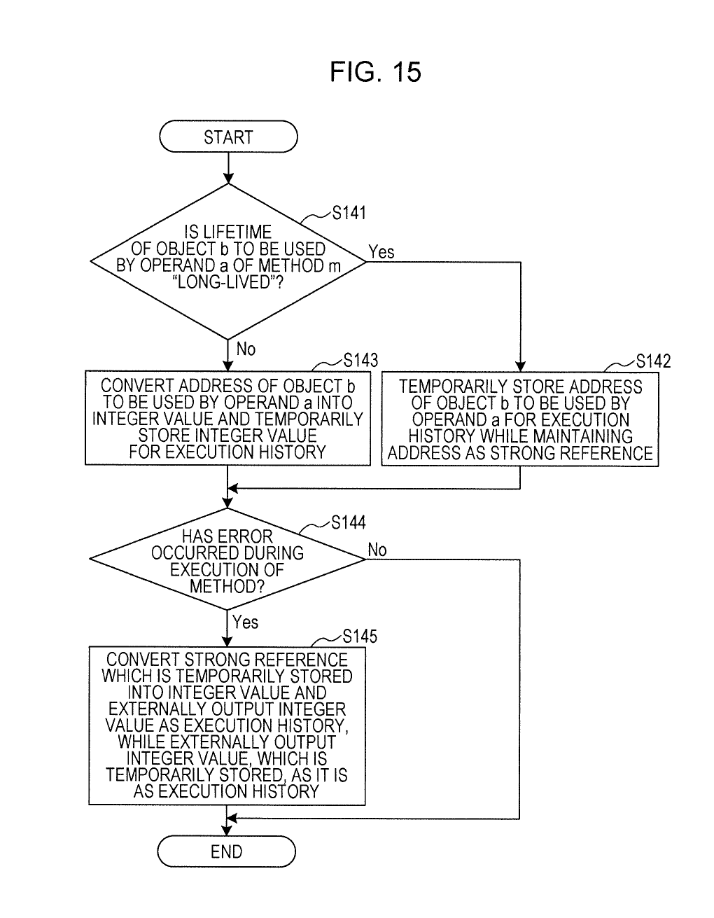

FIG. 15 is a flowchart illustrating a flow of processing of step S14. As illustrated in FIG. 15, the execution history output section 16 performs processing based on whether or not the lifetime of the object b to be used by the operand a of the method m is “long-lived” (step S141). That is, in the case where the lifetime of the object b to be used by the operand a of the method m is “long-lived”, the execution history output section 16 temporarily stores the address of the object b to be used by the operand a for an execution history while maintaining the address as a strong reference (step S142). On the other hand, in the case where the lifetime of the object b to be used by the operand a of the method m is not “long-lived”, the execution history output section 16 converts the address of the object b to be used by the operand a into an integer value and temporarily stores the integer value for an execution history (step S143).

Then, the execution history output section 16 performs processing based on whether or not an error has occurred during the execution of the method (step S144). That is, in the case where an error has occurred during the execution of the method, the execution history output section 16 converts the strong reference which is temporarily stored into an integer value and then externally outputs the integer value as the execution history, while the execution history output section 16 externally outputs the integer value, which is temporarily stored, as it is as the execution history (step S145).

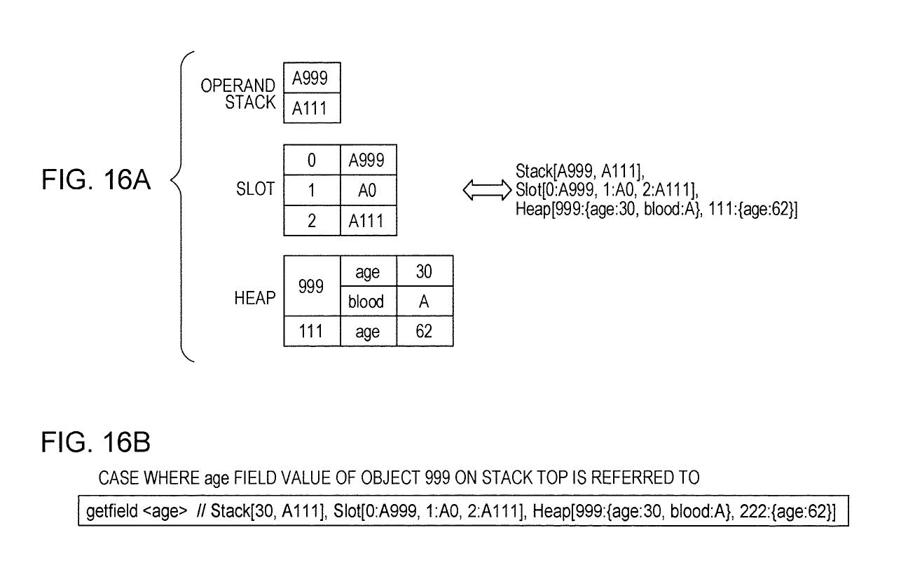

Subsequently, an example of processing performed by the information processing apparatus 1 will be described with reference to FIGS. 16A and 16B to FIG. 20. FIGS. 16A and 16B are diagrams for illustrating a string representation of an execution state used for explanation of a processing example. FIG. 16A illustrates string representation examples of an operand stack, a slot, and a heap, while FIG. 16B illustrates a string representation example of an execution state after bytecode execution.

As illustrated in FIG. 16A, Stack[A999,A111] indicates that “A111” and “A999” are stacked on the operand stack. Slot[0:A999,1:A0,2:A111] represents that address 0 of the slot stores “A999”, address 1 stores “A0”, and address 2 stores “A111”.

Heap[999:{age:30,blood:A},111:{age:62}] represents that the heap stores an object identified by an integer value “999” and an object identified by an integer value “111”. Also, Heap[999:{age:30,blood:A},111:{age:62}] represents that an age field value of the object identified by the integer value “999” is “30”, a blood field value is “A”, and an age field value of the object identified by the integer value “111” is “62”.

Further, FIG. 16B illustrates the states of the operand stack, the slot, and the heap after execution of getfield <age>.

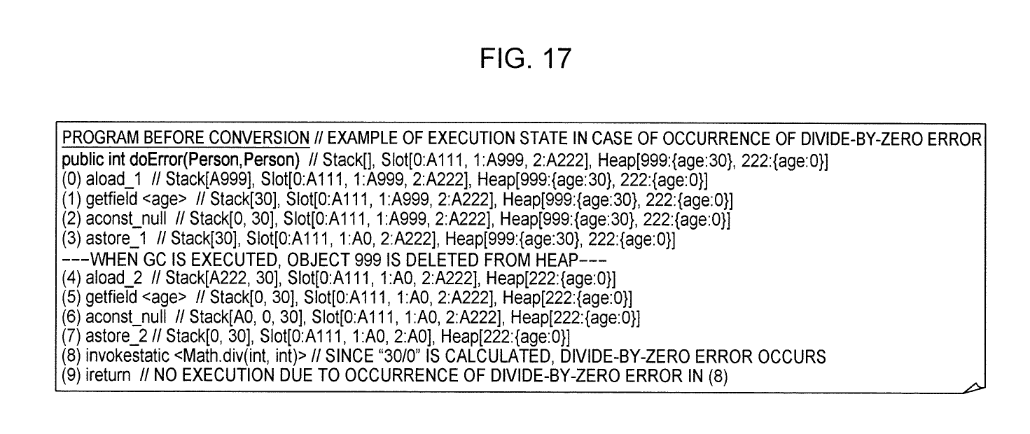

FIG. 17 is a diagram for illustrating a bytecode before conversion. FIG. 17 illustrates a program for receiving two Person-type objects, each of which has an age field, as arguments and dividing an age field value of one object by an age field value of the other object. In the case where a divide number is 0, a divide-by-zero error occurs and method execution ends. Here, it is assumed that the object with the address “A999” is short-lived and the object with the address “A111” is long-lived. That is, when garbage collection is executed, the object with the address “A999” is collected.

As illustrated in FIG. 17, when garbage collection is executed between the definition positions (3) and (4), an object identified by the integer value “999” is deleted from the heap. Further, “30/0” is executed and a divide-by-zero error occurs at the definition position (8).

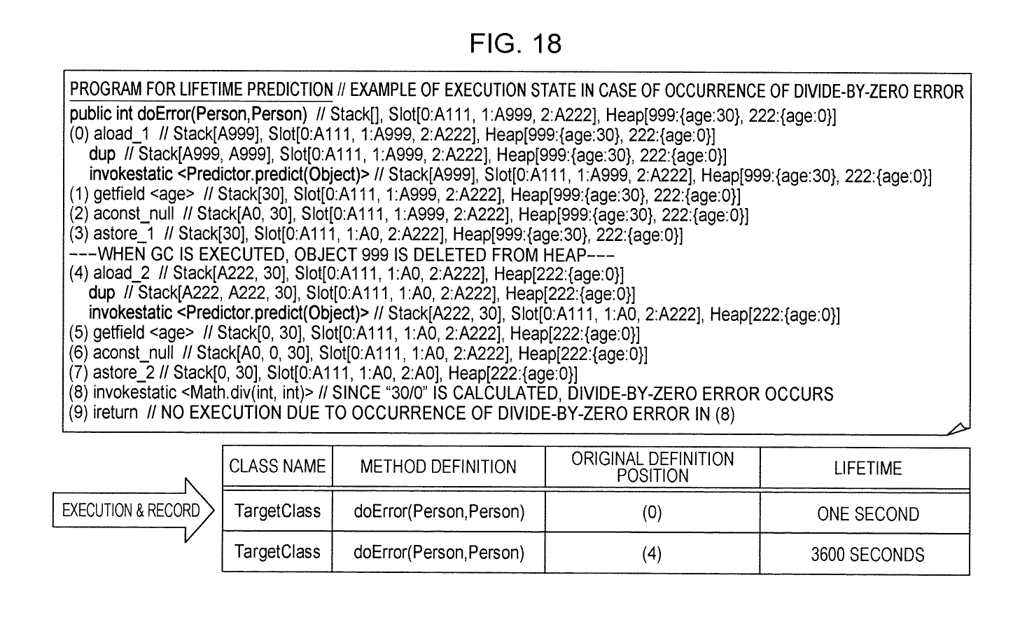

FIG. 18 is a diagram for illustrating a prediction bytecode. As the illustration between the definition positions (0) and (1) and between the definition positions (4) and (5) in FIG. 18, the Predictor. predict(Object) method is called by using object addresses, which are duplicated by a dup instruction, as arguments, immediately after the object is stacked on an operand stack. Then, the tag of the JVMTI 44 is imparted to the object, which is the argument, and time at this point (use time) is recorded. Also, as the illustration between the definition positions (3) and (4), an object to which the tag is imparted is garbage-collected. Then, since the ObjectFree event of the JVMTI 44 is notified, a difference between time at this point (collection time) and the use time is recorded as a lifetime of the object.

In this example, the lifetime of the object used at the definition position (0) (the object with the address “A999”) is “1 second”, and the lifetime of the object used at the definition position (4) (the object with the address “A222”) is “3600 seconds”. Here, when whether an object is short-lived or long-lived is determined based on a threshold value which is set to “5 seconds” instead of method execution time, the object used at the definition position (0) is short-lived and the object used at the definition position (4) is long-lived.

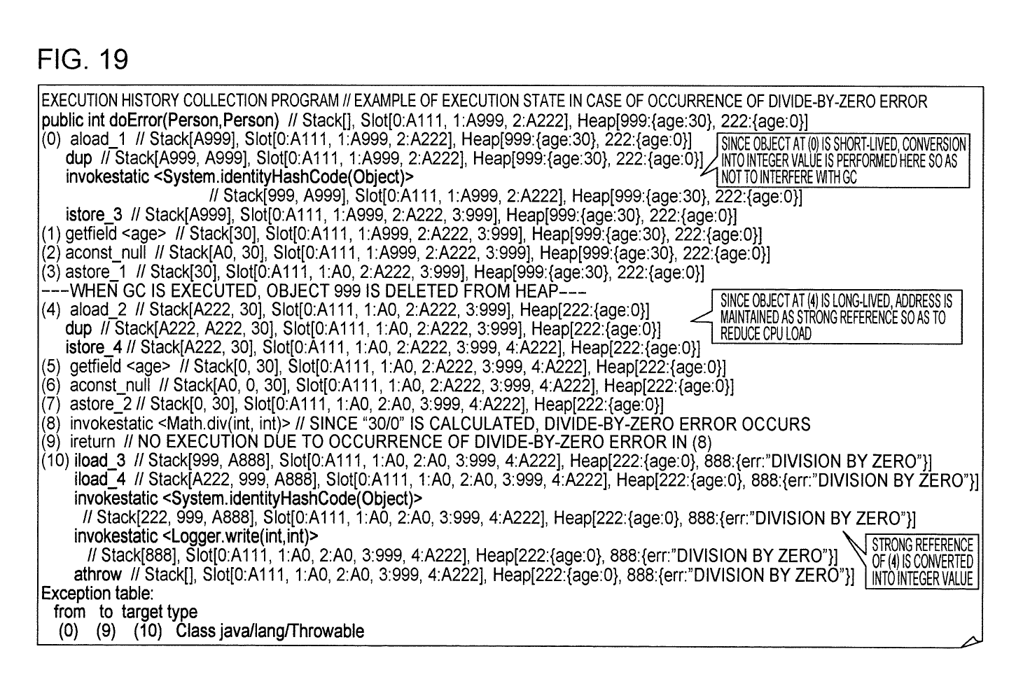

FIG. 19 is a diagram for illustrating a collection bytecode. As illustrated in FIG. 19, since the object at the definition position (0) is short-lived, the address of the object is converted into an integer value so as not to interfere with garbage collection. On the other hand, since the object at the definition position (4) is long-lived, the address of the object is maintained as a strong reference so as to reduce the CPU load. Then, the address of the object at the definition position (4) is converted into an integer value when an error occurs.

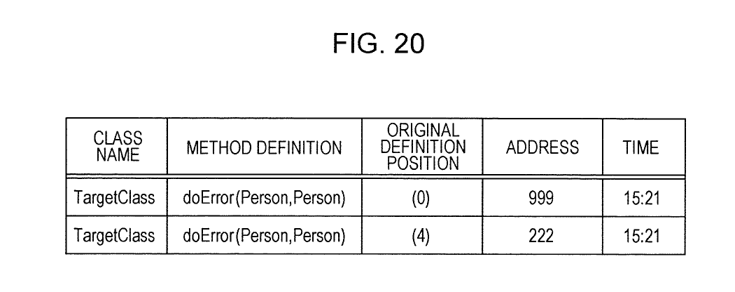

FIG. 20 is a diagram for illustrating a collected execution history. As illustrated in FIG. 20, the integer value “999” of the address of the object used at the definition position (0) and the integer value “222” of the address of the object used at the definition position (4) are recorded in the execution history.

The CPU load is reduced by approximately 99 CPU clocks in this processing example compared to the case where the processing for converting the address of the object used at the definition position (4) into an integer value is executed also in every normal operation in which no error occurs.

As described above, in the first embodiment, the prediction code insertion section 12 inserts a code for predicting a lifetime of an object and the lifetime prediction section 15 predicts the lifetime of the object based on the code inserted by the prediction code insertion section 12. Then, the collection code insertion section 11 switches and inserts a code for recording an execution history based on the lifetime of the object and the execution history output section 16 outputs the execution history based on the code inserted by the collection code insertion section 11. Thus, the information processing apparatus 1 is capable of avoiding increase of execution time without increasing a memory usage.

In addition, in the first embodiment, the lifetime prediction section 15 predicts that a lifetime of an object is long-lived in the case where the lifetime of the object is longer than execution time of a method, while the lifetime prediction section 15 predicts that a lifetime of an object is short-lived in the case where the lifetime of the object is not longer than the execution time of the method. Thus, the lifetime prediction section 15 is capable of appropriately predicting a lifetime of an object.

Further, in the first embodiment, for example, the lifetime prediction section 15 predicts that a lifetime of an object is long-lived in the case where the lifetime of the object is longer than a given threshold value, while the lifetime prediction section 15 predicts that a lifetime of an object is short-lived in the case where the lifetime of the object is not longer than the given threshold value. Thus, the lifetime prediction section 15 is capable of appropriately predicting a lifetime of an object.

### Second Embodiment

Incidentally, though the case where an execution history is collected by predicting a lifetime of an object only once has been described in the first embodiment, a prediction result of a lifetime of an object may change. Therefore, the information processing apparatus 1 which reinserts a code for recording an execution history in accordance with a variable prediction result of a lifetime of an object will be described in the second embodiment.

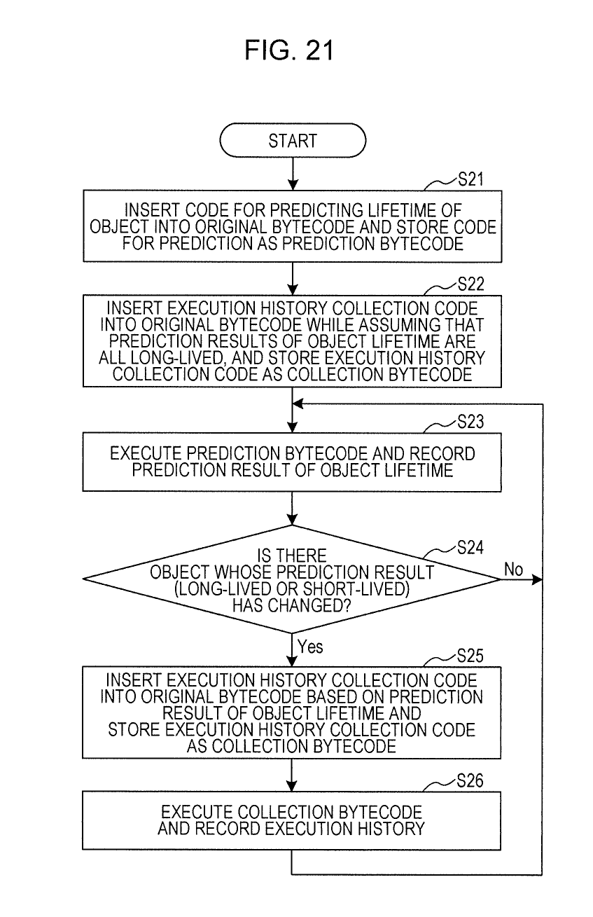

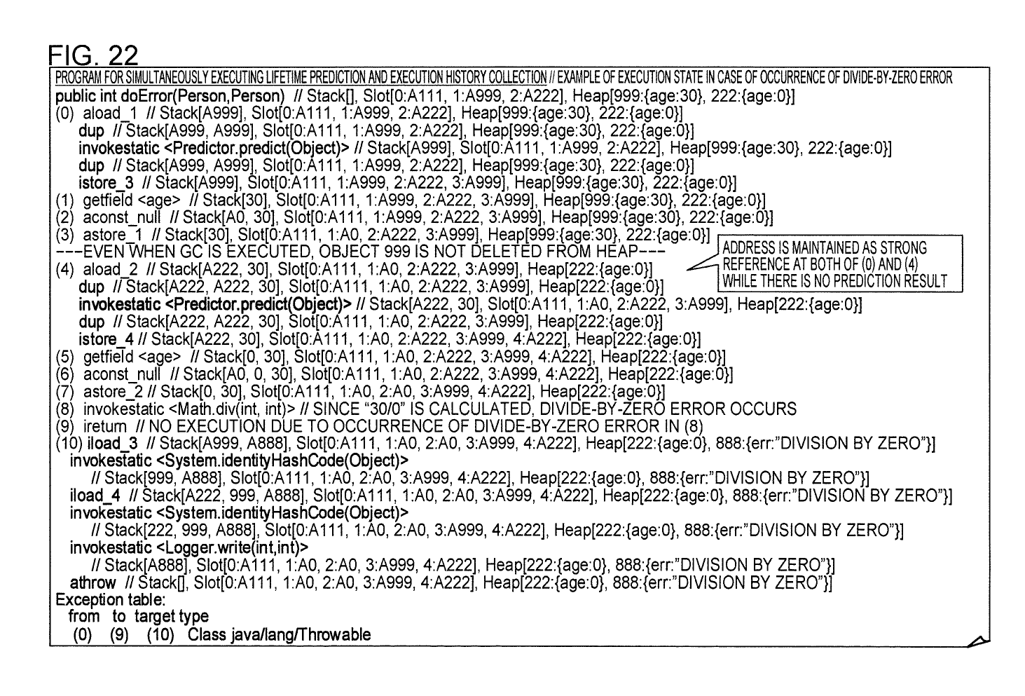

FIG. 21 is a flowchart illustrating a flow of processing performed by the information processing apparatus 1 according to the second embodiment. As illustrated in FIG. 21, the information processing apparatus 1 according to the second embodiment inserts a code for predicting a lifetime of an object into an original bytecode and stores the code for prediction as a prediction bytecode (step S21).

Then, the information processing apparatus 1 according to the second embodiment inserts an execution history collection code into the original bytecode while assuming that prediction results of the object lifetime are all long-lived, and stores the execution history collection code as a collection bytecode (step S22). Subsequently, the information processing apparatus 1 according to the second embodiment executes the prediction bytecode and records a prediction result of the object lifetime (step S23).

Then, the information processing apparatus 1 according to the second embodiment determines whether or not there is an object whose prediction result (long-lived or short-lived) has changed (step S24). In the case where there is no object whose prediction result has changed, the processing returns to step S23.

On the other hand, in the case where there is an object whose prediction result has changed, the information processing apparatus 1 according to the second embodiment inserts an execution history collection code into the original bytecode based on the prediction result of the lifetime of the object and stores the execution history collection code as a collection bytecode (step S25). Subsequently, the information processing apparatus 1 according to the second embodiment executes the collection bytecode and records an execution history (step S26), and the processing returns to step S23.

As described above, the information processing apparatus 1 according to the second embodiment simultaneously executes prediction of a lifetime of an object and history collection. Further, the information processing apparatus 1 according to the second embodiment is capable of dealing with the case where a lifetime of an object changes, by inserting an execution history collection code in accordance with a variable prediction result of a lifetime of an object.

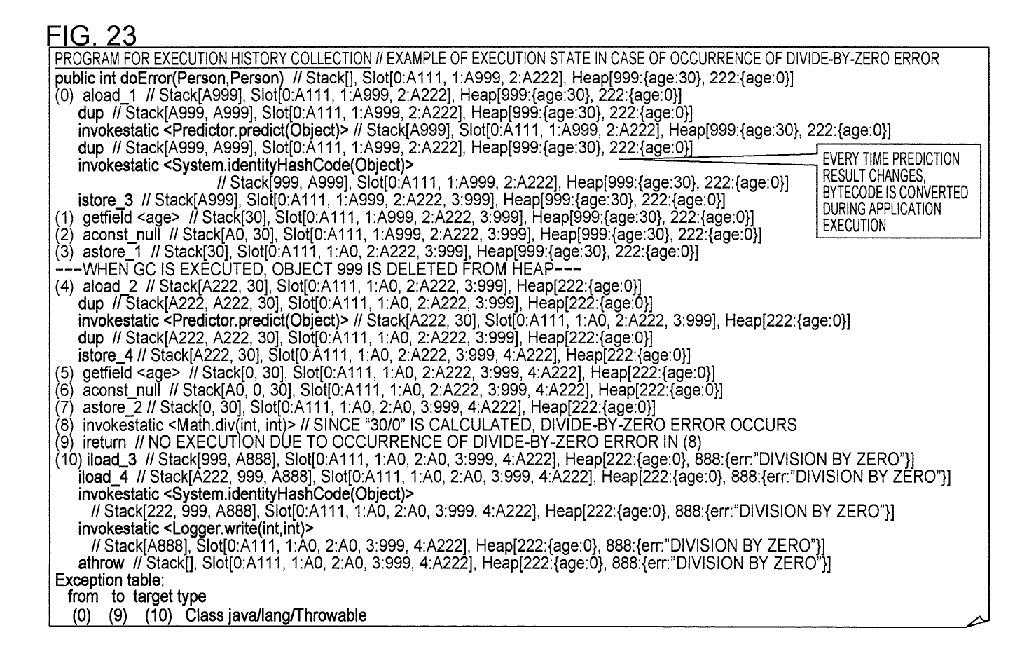

FIG. 22 is a diagram for illustrating a collection bytecode into which an execution history collection code is inserted assuming that prediction results of a lifetime of an object are all long-lived. As illustrated in FIG. 22, while there is no prediction result, an address of an object is maintained as a strong reference at both of the definition position (0) and the definition position (4).

FIG. 23 is a diagram for illustrating a collection bytecode into which an execution history collection code is reinserted based on a prediction result of an object lifetime. Here, the case where the object used at the definition position (0) is predicted to be short-lived is illustrated. Comparing FIG. 23 with FIG. 22, invokestatic <System.identityHashCode(Object)> which is a code for converting the address of the object used at the definition position (0) into an integer value has been moved from a position after the definition position (10) to a position after the definition position (0).

As described above, when a prediction result of a lifetime of an object changes, the information processing apparatus 1 according to the second embodiment reinserts an execution history collection code, thus being able to be dealing also with the case where a lifetime of an object changes.

### Third Embodiment

Though the case where an execution history collection code is switched based on a lifetime of an object has been described in the first and second embodiments above, it is also possible to switch an execution history collection code at the time of execution. Therefore, the information processing apparatus 1 which switches an execution history collection code at the time of execution will be described in the third embodiment.

The information processing apparatus 1 according to the third embodiment creates both of a prediction code and a collection code. In this case, the information processing apparatus 1 according to the third embodiment preliminarily inserts both a code for converting an address of an object into an integer and a code for temporarily holding an address of an object as a strong reference into a collection code. Further, the information processing apparatus 1 according to the third embodiment preliminarily stores a prediction result of a lifetime in a heap, and the collection code refers to the prediction result each time so as to switch codes.

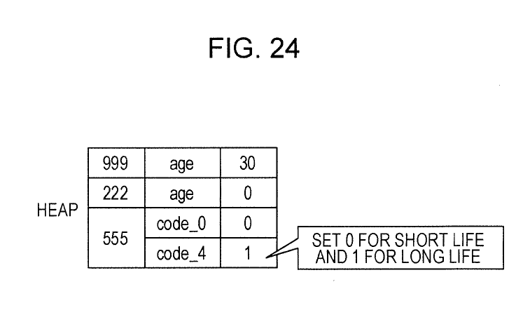

FIG. 24 is a diagram for illustrating a method for referring to a prediction result at the time of execution history collection. In FIG. 24, a prediction result is stored in the code_4 field of an object identified by the integer value “555” in the heap. In the case where a lifetime of the object is short, the value of the code_4 field is “0”, while in the case where a lifetime of the object is long, the value of the code_4 field is “1”.

In an execution state in which the field of the Predictor class may be referred to via the address “A555”, “1” is stacked on the top of an operand stack through an execution of GETSTATIC <Predictor.code_4>(class variable reference instruction)”. Then, through an execution of fine ${label of jump destination}, in the case where the value of the top of the operand stack is 1, it is possible to switch a code to be executed by skipping processing to the label of the jump destination.

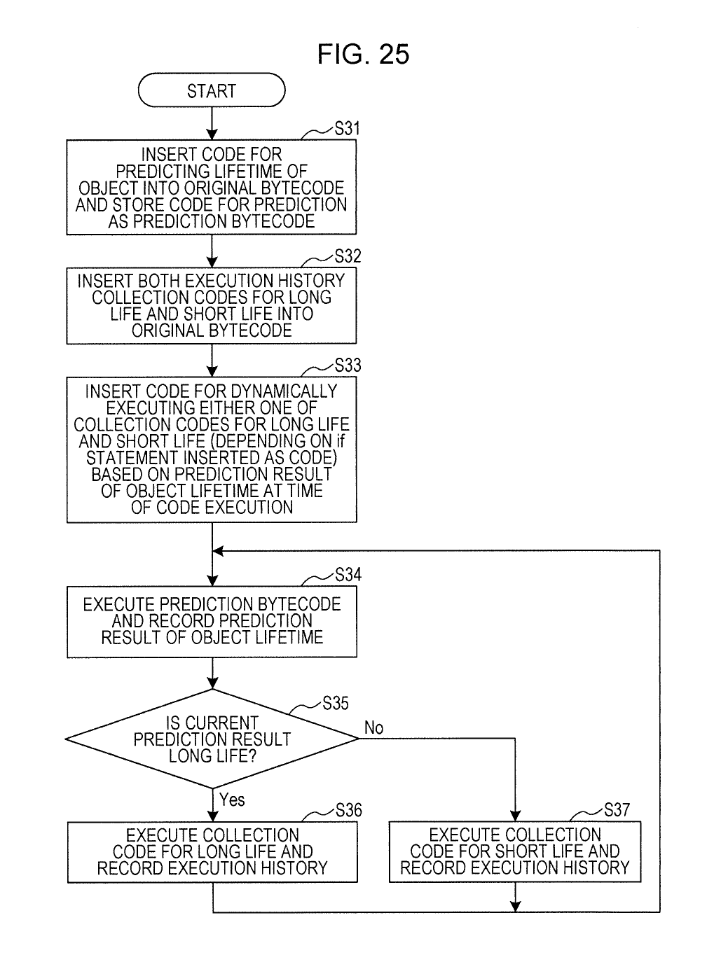

FIG. 25 is a flowchart illustrating a flow of processing performed by the information processing apparatus 1 according to the third embodiment. As illustrated in FIG. 25, the information processing apparatus 1 according to the third embodiment inserts a code for predicting a lifetime of an object into an original bytecode and stores the code for prediction as a prediction bytecode (step S31).

Then, the information processing apparatus 1 according to the third embodiment inserts both execution history collection codes for long life and short life into the original bytecode (step S32). Then, the information processing apparatus 1 according to the third embodiment inserts a code for dynamically executing either one of the collection codes for long life and short life (depending on an if statement inserted as a code) based on a prediction result of the lifetime of the object at the time of code execution (step S33).

Subsequently, the information processing apparatus 1 according to the third embodiment executes the prediction bytecode and records the prediction result of the object lifetime (step S34). Then, the information processing apparatus 1 according to the third embodiment determines whether or not a current prediction result is long life (step S35). In the case where the current prediction result is long life, the information processing apparatus 1 executes the collection code for long life and records the execution history (step S36). After that, the information processing apparatus 1 according to the third embodiment returns to step S34.

On the other hand, in the case where the current prediction result is not long life, the information processing apparatus 1 according to the third embodiment executes the collection code for short life and records the execution history (step S37). After that, the information processing apparatus 1 according to the third embodiment returns to step S34.

As described above, the information processing apparatus 1 according to the third embodiment inserts a code for executing either one of codes for long life and short life and executes either one of the codes for long life and short life based on a prediction result, which is obtained at the time of execution, of a lifetime of an object. Accordingly, the information processing apparatus 1 according to the third embodiment is capable of dealing also with the case where a lifetime of an object changes.

### Fourth Embodiment

The case where collection of an execution history is repeated to deal with the case where a lifetime of an object changes has been described in the third embodiment. However, also in the case where a lifetime of an object is predicted only once, either one of the codes for long life and short life may be executed at the time of collection of an execution history. Therefore, in the fourth embodiment, the case will be described in which a lifetime of an object is predicted only once and either one of codes for long life and short life is executed at the time of collection of an execution history.

The information processing apparatus 1 according to the fourth embodiment preliminarily inserts both a code for converting an address of an object into an integer and a code for temporarily holding an address of an object as a strong reference into a collection code. Further, the information processing apparatus 1 according to the fourth embodiment refers to a prediction result in the same manner as the third embodiment and the collection code switches codes at the time of execution.

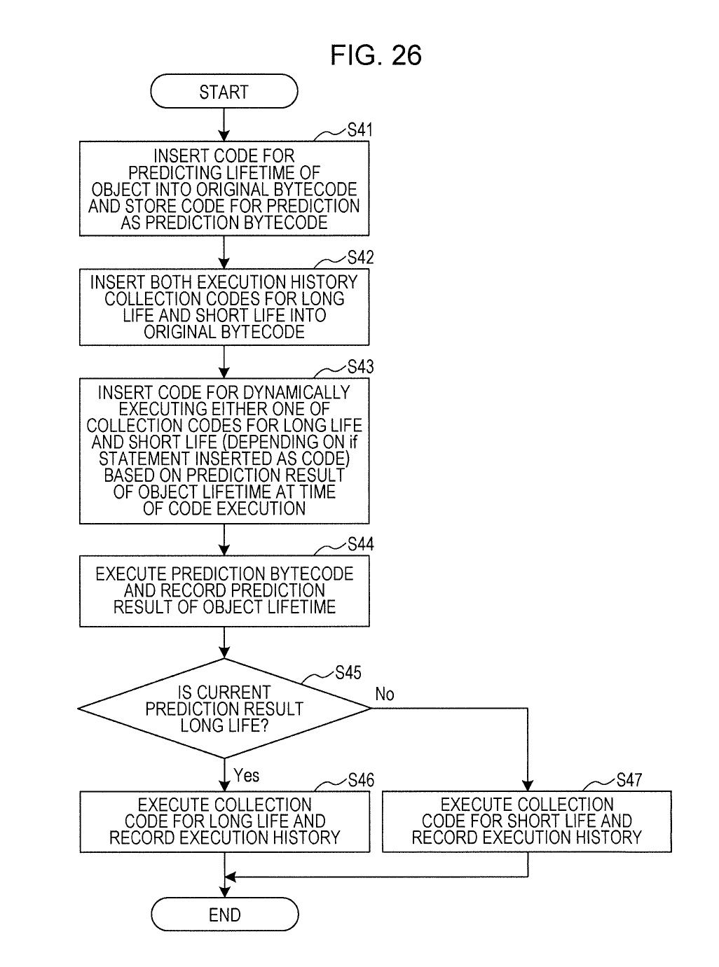

FIG. 26 is a flowchart illustrating a flow of processing performed by the information processing apparatus 1 according to the fourth embodiment. As illustrated in FIG. 26, the information processing apparatus 1 according to the fourth embodiment inserts a code for predicting a lifetime of an object into an original bytecode and stores the code for prediction as a prediction bytecode (step S41).

Then, the information processing apparatus 1 according to the fourth embodiment inserts both execution history collection codes for long life and short life into the original bytecode (step S42). Subsequently, the information processing apparatus 1 according to the fourth embodiment inserts a code for dynamically executing either one of the collection codes for long life and short life (depending on an if statement inserted as a code) based on a prediction result of the lifetime of the object at the time of code execution (step S43).

After that, the information processing apparatus 1 according to the fourth embodiment executes the prediction bytecode and records the prediction result of the lifetime of the object (step S44). Then, the information processing apparatus 1 according to the fourth embodiment determines whether or not a current prediction result is long life (step S45). In the case where the current prediction result is long life, the information processing apparatus 1 executes the collection code for long life and records the execution history (step S46). On the other hand, in the case where the current prediction result is not long life, the information processing apparatus 1 according to the fourth embodiment executes the collection code for short life and records the execution history (step S47).

As described above, the information processing apparatus 1 according to the fourth embodiment inserts a code for executing either one of the codes for long life and short life and executes either one of the codes for long life and short life based on one prediction result of a lifetime of an object. Therefore, the information processing apparatus 1 according to the fourth embodiment is capable of generating a collection code without switching codes at the time of insertion of an execution history collection code.

In the embodiments, the case where an execution history of the Java program is collected has been described. However, the present disclosure is not limited to this and the present disclosure is similarly applicable to a program created by other object-oriented languages such as Ceylon as well.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, and the processor configured to:
predict whether a lifetime of an object, the object being generated at time of execution, is longer than a given threshold value, and
process a first processing for storing an address of the object when the lifetime of the object is longer than the given threshold value and a second processing for converting the address of the object into an integer value to store the integer value when the lifetime of the object is not longer than the given threshold value.

2. The information processing apparatus according to claim 1, wherein the processor is configured to switch a code for collecting the address during an execution of a program so as to switch between the first processing and the second processing.

3. The information processing apparatus according to claim 1, wherein
the processor is configured to predict whether a lifetime of the object is longer than execution time of a method which refers to the object, and
the processor is configured to:
store an address of the object when the lifetime of the object is longer than the execution time of the method for referring to the object, and
convert the address of the object into an integer value to store the integer value when the lifetime of the object is not longer than the execution time of the method for referring to the object.

4. The information processing apparatus according to claim 1, wherein the processor adds a tag, in which use time is recorded when the object is used, to the object, records collection time when the object is collected by a garbage collector, and predicts the lifetime based on the use time and the collection time.

5. An information processing method in which a computer executes processing, comprising:
predicting a lifetime of an object, the object being generated at time of execution; and
switching a processing for storing an address of the object so as to collect the address as an execution history when an error occurs during an execution of a program which uses the object and a processing for converting the address of the object into an integer value to store the integer value, based on a predicted result.

6. A non-transitory, computer-readable recording medium having stored therein a program for causing a computer to execute a process, the process comprising:
predicting a lifetime of an object; and
switching a processing for storing an address of the object so as to collect the address as an execution history when an error occurs during an execution of a program which uses the object, the object being generated at time of execution, and a processing for converting the address of the object into an integer value to store the integer value, based on a predicted result.
